(19) United States
(12) Patent Application Publication
(10) Pub. No.: US 2015/0087737 A1
(43) Pub. Date: Mar. 26, 2015

(54) Hydrophilic Polyurethane Foam for Liquid Based Cleaning Applications

(71) Applicant: Dow Global Technologies LLC, Midland, MI (US)

(72) Inventors: Yasmin N. Srivastava, Sugar Land, TX (US); Subodh P. Jagtap, Lake Jackson, TX (US); Venkat S. Minnikanti, Delray Beach, FL (US); Rogelio Gamboa, Brazoria, TX (US); Dwight Latham, Clute, TX (US); Rajat Duggal, Pearland, TX (US)

(21) Appl. No.: 14/489,537

(22) Filed: Sep. 18, 2014

Related U.S. Application Data
(60) Provisional application No. 61/881,478, filed on Sep. 24, 2013.

(51) Int. Cl. C08G 18/08; C08G 18/10

(52) U.S. Cl. CPC C08G 18/14; C08G 18/10
USPC 521/159

(57) ABSTRACT

A reaction system for forming a hydrophilic polyurethane foam for liquid based cleaning applications includes a composition that has a prepolymer component and an aqueous component. The prepolymer component is a reaction product of an isocyanate component that includes diphenylemethane diisocyanate (MDI) and a polyol component that includes a polyoxyethylene-polyoxypropylene polyol that has an polyoxyethylene content greater than 65 wt %, based on a total weight of the polyoxyethylene-polyoxypropylene polyol. The aqueous component includes at least 60 wt % of water and at least 0.5 wt % of a surfactant, based on a total weight of the aqueous component. A weight ratio of the prepolymer component to the aqueous component in the composition is from 0.5:2 to 2:0.5, the composition has a cream time of less than 20 seconds and a tack free time of less than 7 minutes, and the hydrophilic polyurethane foam for liquid based cleaning applications has a wet tear strength of at least 500 N/m.

### FIELD

Embodiments relate to a hydrophilic polyurethane foam used in liquid based cleaning applications that is prepared using a MDI based prepolymer.

### INTRODUCTION

Hydrophilic polyurethane foams may be prepared by a process in which a hydrophilic prepolymer having isocyanate end groups is mixed and reacted with water, e.g., as discussed in WO 2004/074343. The hydrophilic polyurethane foams formed with diphenylemethane diisocyanate (MDI) are characterized by greater hydrolytic stability than foams formed with toluene diisocyanate (TDI) prepolymers. For example, TDI based prepolymers demonstrate poor wet tear properties, which leads to difficulties when forming hydrophilic polyurethane foams used in liquid based cleaning applications. However, despite the poor wet tear properties, TDI based prepolymers are still used extensively due to the reactivity profile of MDI prepolymers, which reactivity profile can cause processing difficulties when forming hydrophilic polyurethane foams. Accordingly, an improved formulation for forming hydrophilic polyurethane foams that demonstrates an improved reactivity profile coupled and uses MDI based prepolymers is sought.

### SUMMARY

A reaction system for forming a hydrophilic polyurethane foam for liquid based cleaning applications includes a composition that has a prepolymer component and an aqueous component. The prepolymer component is a reaction product of an isocyanate component that includes diphenylemethane diisocyanate (MDI) and a polyol component that includes a polyoxyethylene-polyoxypropylene polyol that has an polyoxyethylene content greater than 65 wt %, based on a total weight of the polyoxyethylene-polyoxypropylene polyol. The aqueous component includes at least 60 wt % of water and at least 0.5 wt % of a surfactant, based on a total weight of the aqueous component. A weight ratio of the prepolymer component to the aqueous component in the composition is from 0.5:2 to 2:0.5, the composition has a cream time of less than 20 seconds and a tack free time of less than 7 minutes, and the hydrophilic polyurethane foam for liquid based cleaning applications has a wet tear strength of at least 500 N/m.

### DETAILED DESCRIPTION

Embodiments relate to a hydrophilic polyurethane foam for use in liquid based cleaning applications that has a wet tear strength adapted for use in highly hydrolytic conditions. In particular, the hydrophilic polyurethane foam has a wet tear strength of at least 500 N/m, at least 570 N/m, at least 1000 N/m, and/or at least 1100 N/m. For example, the hydrophilic polyurethane foam has a wet tear strength from 500 N/m to 2,000 N/m (e.g., 510 N/m to 1,500 N/m, 520 N/m to 1400 N/m, 550 N/m to 1300 N/m, 570 N/m to 1200 N/m, etc.). Exemplary hydrophilic polyurethane foams for liquid based cleaning applications include bath sponges, dish washing sponges, floor cleaning sponges, and scrubbing sponges. The hydrophilic polyurethane foam may have a density from 5.0 lb/ft³ to 10 lb/ft³ (e.g., 8.5 lb/ft³ to 9.5 lb/ft³), and the hydrophilic polyurethane foam may have a density from 80 kg/m³ to 160 kg/m³ (e.g., 136 kg/m³ to 152 kg/m³).

A formulation for forming the hydrophilic polyurethane foam for use in liquid based cleaning applications includes a prepolymer component (such as a MDI based prepolymer) and an aqueous component. Embodiments relate to the preparation of the hydrophilic polyurethane foam for use in liquid based cleaning applications using a formulation that includes methylene diphenylisocyanate (MDI) based prepolymers (i.e., isocyanate-terminated MDI based prepolymers) and that exhibits a good reactivity profile based on a combination of back end reactivity, e.g., a tack free time of less than 7 minutes, and front end reactivity, e.g., a cream time of less than 20 seconds. Tack free time is measured as a time difference been when a reaction mixture that includes the MDI based prepolymers is formed until a reaction product of the reaction mixture becomes tack free, i.e., is sufficiently hardened that an inert object may be inserted into the reaction product without stringing/sticking being realized. Cream time is measured as the time difference from when a reaction mixture that includes the MDI based prepolymers is formed until a visual change of an increase in volume (i.e., rise) of the reaction mixture occurs. According to exemplary embodiments, the tack free time may be less than 6 minutes, equal to or less than 5 minutes, from 2 minutes to 6 minutes, and/or from 3.5 minutes to 5.5 minutes. The cream time may be less than 18 seconds, less than 16 seconds, from 10 seconds to 16 seconds, and/or from 13 to 16 seconds.

The prepolymer component includes at least one isocyanate-terminated prepolymer that is a reaction product of an isocyanate component and a polyol component. According to embodiments, the isocyanate component includes MDI and the polyol component includes at least a polyoxyethylene-polyoxypropylene polyol that has a polyoxyethylene content greater than 65 wt % (based on a total weight of the polyoxyethylene-polyoxypropylene polyol), based on a total weight of the polyoxyethylene-polyoxypropylene polyol. A remainder of the weight content of the polyoxyethylene-polyoxypropylene polyol based on a total of 100 wt % is accounted for with polyoxypropylene, e.g., the polyoxypropylene content is at least 5 wt %. The aqueous component includes at least water and a surfactant. A weight ratio of the prepolymer component to the aqueous component in the mixture is from 0.5:2 to 2:0.5 (e.g., 0.75:1.5 to 1.5:0.75, 0.9:1.1 to 1.1:0.9, etc.). The hydrophilic polyurethane foam is a cured reaction product of a mixture that includes the prepolymer component and the aqueous component.

According to embodiments, the prepolymer component in the formulation for preparing the hydrophilic polyurethane foam for use in liquid based cleaning applications includes at least one isocyanate-terminated prepolymer prepared using MDI (i.e., a MDI based prepolymer). In particular, the MDI based prepolymer is prepared using polymeric MDI and/or mixtures of different isomers of MDI, e.g., using 4,4′-diphenylemethane diisocyanate (4,4′ isomer of MDI) and/or 2,4′-diphenylemethane diisocyanate (2,4′ isomer of MDI). The free isocyanate group content (i.e., NCO content) of the MDI based prepolymer may be from 1 wt % to 25 wt %, based on a total weight of the prepolymer. According to an exemplary embodiment, the free NCO content may be from less than 15 wt %, less than 10 wt %, and/or less than 8 wt % (e.g., from 5 wt % to 15 wt %, 6 wt % to 13 wt %, 7 wt % to 12 wt %, 5 wt % to 11 wt %, 7 wt % to 10 wt %, etc.). Polyisocyanate may be back blended into the MDI based prepolymer to reach the desired free NCO content.

The MDI based prepolymer may be the reaction product of the isocyanate component and the polyol component. The isocyanate component includes methylene diphenylisocyanate (MDI), in which the 2,4′-and 4,4′-diphenylemethane diisocyanate isomers of MDI are present in the isocyanate component in a weight ratio from 0:100 to 50:50. For example, the 2,4′ isomer of MDI may be present in an amount from 5 wt % to 50 wt % (e.g., 10 wt % to 50 wt %, 15 wt % to 35wt %, 20 wt % to 30 wt %, etc.), based on a total weight of the isocyanate component.

According to an exemplary embodiment, a weight percentage of the 4,4′ isomer of MDI is greater than a weight percentage of the 2,4′ isomer of MDI, based on a total weight of the isocyanate component. For example, a formulation for forming the MDI based prepolymer has a 2,4′ isomer of MDI content from 1.5 wt % to 40 wt % (e.g., 1.5 wt % to 30 wt %) and a remainder of the 4,4′ isomer of MDI, based on a total weight of 100 wt % of the formulation for forming the prepolymer component. According to exemplary embodiments, a balance of the isocyanate component that is not accounted for with the 4,4′ isomer of MDI and/or the 2,4′ isomer of MDI may include toluene diisocyanate, hexamethylene diisocyanate, isophorone diisocyanate, polymethylene polyphenylisocyanate, carbodiimide or allophonate or uretonimine adducts of methylene diphenylisocyanate, and mixtures thereof.

The polyol component includes at least one polyether polyol having an average nominal hydroxyl functionality from 1.6 to 8 (e.g., 1.6 to 3.5) and a number average molecular weight from 1000 to 12,000 (e.g., 1,000 to 8,000, 1,200 to 6,000, 2,000 to 5,500, etc.). In particular, the polyol component includes at least one polyoxyethylene-polyoxypropylene polyol. Combinations of other polyether polyols, including monohydroxyl substances and low molecular weight diol and triol substances or amines, of varying functionality and polyoxyethylene content may be used in the formulation for preparing the prepolymer component.

According to embodiments, the polyol component includes at least one polyoxyethylene-polyoxypropylene polyol that has a polyoxytheylene content greater than 65 wt %, greater than 70 wt %, and/or at least 75 wt %, based on a total weight of the polyoxyethylene-polyoxypropylene polyol. A remainder of the weight content of the polyoxyethylene-polyoxypropylene polyol based on a total of 100 wt % is accounted for with polyoxypropylene. For example, the polyoxyethylene-polyoxypropylene polyol may have a polyoxypropylene content of at least 5 wt % (e.g., at least 10 wt %, at least 15 wt %, and/or at least 20 wt %) and a polyoxytheylene content greater than 65 wt %, based on a total weight of the polyoxyethylene-polyoxypropylene polyol. The polyoxyethylene-polyoxypropylene polyol may account for from 5 wt % to 100 wt % (e.g., 9 wt % to 100 wt %, 95 wt % to 100 wt %, etc.) of the polyol component. The polyoxyethylene-polyoxypropylene polyol may have an average nominal hydroxyl functionality from 1.6 to 3.5 (e.g., 2.5 to 3.5) and a number average molecular weight from 1,500 to 8,000 (e.g., 2,000 to 6,000, 3,000 to 5,500, 4,000 to 5,300, etc.). The polyoxyethylene content of the individual polyols may be randomly distributed throughout the molecule. According to an exemplary embodiment, the polyol component includes only the polyoxyethylene-polyoxypropylene polyol, and thus the polyol component has a polyoxytheylene content greater than 65 wt %, greater than 75 wt %, and/or at least 75 wt %, based on a total weight of the polyol component.

According to another exemplary embodiment, in addition to the polyoxyethylene-polyoxypropylene polyol, the polyol component includes at least one polyalkylene glycol based polyol. The polyalkylene glycol ether polyol may have a nominal hydroxyl functionality from 1.6 to 3.5 (e.g., 1.5 to 2.5, etc.) and a number average molecular weight from 1,500 to 8,000 (e.g., 2,000 to 5,000, 2,000 to 4,000, etc.). An amount of the polyalkylene glycol based polyol in the polyol component may be greater than an amount of the polyoxyethylene-polyoxypropylene polyol. For example, a weight ratio of the polyoxyethylene-polyoxypropylene polyol to the polyalkylene glycol based polyol may be from 1:5 to 1:15 (e.g., 1:7 to 1:11, 1:9 to 1:10, etc.), in the polyol component.

According to an exemplary embodiment, the polyalkylene glycol may be a polyethylene glycol (PEG) polyol having the following formula:

H—(O—CH₂—CH₂)ₙ—OH

wherein, n is selected to give the desired average molecular weight from 1,500 to 8,000.

According to another exemplary embodiment, the polyalkylene glycol based polyol may have the following formula:

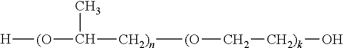

wherein, n and k are selected to give the desired average molecular weight from 1,500 to 8,000.

When manufacturing the hydrophilic polyurethane foam, a crosslinking agent may be incorporated into the prepolymer component (e.g., may be added before the MDI based prepolymer is exposed to the aqueous component). Introduction of the crosslinking agent may facilitate preparation of foam when the aqueous component is introduced to the MDI based prepolymer. Exemplary crosslinking agents include diol and triol polyols and low molecular weight amines having 3 or 4 amine moieties. Exemplary crosslinking agents include glycerine, trimethylolpropane and low molecular weight alkotylated derivatives thereof, and ethylene diamine. The crosslinking agent may be present in an amount from 0.1 wt % to 5 wt % (e.g., from 0.5 wt % to 3 wt %, 1 wt % to 2.5 wt %), based on the total amount by weight the polyol component.

The at least one isocyanate of the isocyanate component and the at least one polyol of the polyol component used in the embodiments may independently be commercially available and/or may be produced using processes known to those skilled in the art. For example, the polyether polyol may be obtained by reacting ethylene oxide and/or propylene oxide simultaneously and/or sequentially in any order with at least one initiator having 2 to 8 active hydrogen atoms. Exemplary initiators include water, ethylene glycol, propylene glycol, butanediol, glycerol, trimethyol propane, ethylene diamine, triethanolamine, sucrose, and sorbitol.

The prepolymer component, e.g., the MDI based prepolymer, may be prepared by combining the isocyanate component and the polyol component at 20-100° C. If desired, the prepolymer component may be prepared in the presence of urethane-forming catalyst, such as a tertiary amine or tin compound.

In making a polyurethane product, the ratio of the amount of the prepolymer component (e.g., of the MDI based prepolymer) to the aqueous component may vary. When preparing the hydrophilic foam for use in liquid based cleaning applications, the weight ratio of the prepolymer component (e.g., of the MDI based prepolymer) to the aqueous component in the mixture is from 0.5:2 to 2:0.5 (e.g., 0.75:1.5 to 1.5:0.75, 0.9:1.1 to 1.1:0.9, etc.). The aqueous component mainly includes water, e.g., at least 60 wt %, at least 70 wt %, at least 80 wt %, at least 90 wt %, at least 95 wt %, and/or at least 98 wt % of the aqueous component is water, and includes a minor amount of surfactant. The aqueous component may also include minor amounts of a catalyst and/or a thickening agent as exemplary optional additives and other optional additives may be present. The optional additives may be introduced via the aqueous component and/or the prepolymer component.

According to embodiments, the aqueous component is a water based solution that includes at least one surfactant. The aqueous component may include at least 0.5 wt % (e.g., 0.5 wt % to 10 wt %, 0.75 wt % to 3 wt %, 1 wt % to 2.5 wt %, etc.) of the surfactant. The surfactant may be a copolymer of oxyethylene and oxypropylene such as the Pluronic® surfactants available from BASF (e.g., the Pluronic trade name includes designated products L-62, L-72, 1-92, P-75, and P-85) or a copolymer of silicone, ethylene oxide, and/or propylene oxide such as the Silwet™ surfactants available from Momentive.

Optionally, at least one catalyst may be premixed with the aqueous component (and/or the prepolymer component). The catalyst may be added in an amount to modify the curing time of the reaction product and facilitate in attaining the desired physical attributes of the foam. Suitable catalysts include, e.g., substances known in the art for promoting the reaction of an isocyanate with a polyol. For example, the catalyst may include a sodium bicarbonate, a tertiary amine, and/or an organometallic compound. Exemplary catalysts include n-methyl morpholine, n-ethyl morpholine, trimethylamine, triethylamine, tetramethyl butane diamine, triethylenediamaine, dimethylaminoethanolamine, benzylidimethylamine, dibutyl tin dilaurate, and stannous octoate.

Optionally, at least one thickening agent may be present, e.g., when it is desired to control the viscosity of the aqueous phase and facilitate the transportation and distribution substances such as fillers and/or fibers. Exemplary thickening agents include natural products such as xanthan gums and chemical agents such as polyacrylamide polymers and gels (e.g., as available from The Dow Chemical Company).

Other optional additive such as mixing aids, emulsifiers, as fatty oils, and/or functional additives, may be present (e.g., in the aqueous component) when modified physical properties are sought. Other additives present may be fragrances, perfumes, and/or other substances that may be detected by scent. If physiological active properties are sought in the final foam product, e.g., the aqueous component may be used to introduce active molecules such as pesticides, insecticides, herbicides, attractants, and/or plant or animal nutrients. If electrical or luminescent properties are sought, e.g., the aqueous component may be used to introduce electrolytes so as to render the polymer electro-conductive or fluorescent/phosphorescent additives so as to render the polymer luminescent.

An exemplary method for forming a final polyurethane foam product includes bringing the aqueous component to a temperature from 5° C. to 50° C. and introducing the prepolymer component to form a mixture. The mixture is then brought to a reaction area, e.g., a mold or a pour area, dispensed, and then allowed to react.

All parts and percentages herein are by weight, unless otherwise indicated. All descriptions of molecular weight are based on a number average molecular weight, unless otherwise indicated.

### EXAMPLES

The following materials are principally used:

| | |
|---|---|
| UCON ™ | A lubricant polyol of a polyalkylene glycol monobutyl |
| PCL-270 | ether, having an average nominal hydroxyl functionality |
| | of 2 and a number average molecular weight of 2,400 |
| | (available from The Dow Chemical Company). |
| VORANOL ™ | A polyoxyethylene/polyoxypropylene polyol initiated |
| CP-1421 | with glycerol, having an average nominal hydroxyl |
| | functionality of 3, an average hydroxyl number of |
| | 33 KOH/g, an average polyoxyethylene content of 75 |
| | wt %, and a number average molecular weight of 5,000 |
| | (available from The Dow Chemical Company). |
| Poly-G ® | A polyoxyethylene/polyoxypropylene polyol, having |
| 22-56 | an average nominal hydroxyl functionality of 2, an |
| | average hydroxyl number of 56 KOH/g, an average |
| | polyoxyethylene content of 75 wt %, and a number |
| | average molecular weight of 2,000 (available from |
| | Lonza). |
| ISONATE ™ | A MDI based mixture including on average 98 wt % |
| 125M | 4,4′-diphenylmethane diisocyanate and 2 wt % of |
| | 2,4′-diphenylemethane diisocyanate and having an |
| | average NCO content of 33.5 wt % (available from The |
| | Dow Chemical Company). |
| ISONATE ™ | A MDI based mixture including on average 50 wt % |
| 50 O,P | 4,4′-diphenylmethane diisocyanate and 50 wt % of |
| | 2,4′-diphenylemethane diisocyanate and having an |
| | average NCO content of 33.5 wt % (available from The |
| | Dow Chemical Company). |
| TDI Pre- | A toluene diisocyanate (TDI) based prepolymer having |
| polymer | an NCO content range of 5.7 wt % to 6.3 wt % (available |
| | under the tradename HYPOL ™ from The Dow |
| | Chemical Company). |
| MDI Pre- | A MDI based prepolymer prepared using ISONATE ™ |
| polymer | 50 O,P and UCON ™ PCL-270, having an NCO content |
| | range of 8.8 wt % to 9.7 wt %. |
| Poloxamer | A non-ionic copolymer surfactant that includes 10 wt % |
| 188 | of Pluronic ® F-68, which is an ethylene oxide/propyl- |
| | ene oxide block copolymer available from BASF, in cell |
| | culture grade water (available from Sigma-Aldrich). |
| Benzoyl | A 99 wt % solution of benzoyl chloride (available from |
| Chloride | Sigma-Aldrich). |

Prepolymer Formulation 1 with a target average NCO content of 7 wt % and Prepolymer Formulation 2 are prepared according to Table 1, below. The NCO content is measured according to ASTM D5155.

TABLE 1

| | Prepolymer | Prepolymer |
|---|---|---|
| | Formulation 1 | Formulation 2 |
| | (wt %) | (wt %) |
| UCON ™ PCL-270 | 66 | |
| VORANOL ™ CP-1421 | 7 | |
| Poly G22-56 | | 64 |
| ISONATE ™ 125M | 16 | 36 |
| ISONATE ™ 50 O,P | 11 | |
| Benzoyl Chloride | <0.01 | <0.01 |

With respect to the Prepolymer Formulation 1, the required amount of UCON™ PCL-270 and VORANOL™ CP-1421, according to Table 1, above, are added to a reactor to form a first mixture that is heated to 100° C. with continuous stirring and nitrogen purging overnight. Then, after the water content is measured to make sure it is less than 250 ppm, Benzoyl Chloride is added to the first mixture to form a second mixture. Thereafter, the second mixture is stirred for 15 min. Also, ISONATE™ 125M and ISONATE™ 50 O,P are added to a four neck flask to form a third mixture, which is heated to 50° C. Next, the second mixture is added to the third mixture, and the resultant mixture is heated to 75° C. and maintained at that temperature for three hours. Thereafter, the temperature of the resultant mixture is lowered down to 60-65° C. and the prepolymer is dispensed into a glass bottle. Prepolymer Formulation 2 is prepared according to the required amounts in Table 1 using the same method as described with respect to the Prepolymer Formulation 1.

Next, Working Example 1 is prepared with a 1:1 ratio of the Prepolymer Formulation 1 to a solution (which solution includes 2 wt % of Poloxamer 188 and 98 wt % of water). In particular, the prepolymer prepared above and the solution are added to a mixing cup to form a reaction mixture that is mixed using a lab scale speedmixer for 20 seconds at 2000 rpm. Then, the reaction mixture is poured into a 12 inch by 12 inch mold with a polyethylene sheet. The reaction product of the reaction mixture is allowed to set for twenty four hours prior to demolding and drying, and the reaction product is dried in an oven at 70° C. for five to seven hours. Working Example 2 is prepared using a 1:1 ratio of the Prepolymer Formulation 2 to a solution (which solution includes 2 wt % of Poloxamer 188 and 98 wt % of water), using the same method as described with respect to Working Example 1.

Comparative Example A uses TDI instead of MDI and is prepared with a 1:1 ratio of the TDI Prepolymer and a solution (which solution includes 2 wt % of Poloxamer 188 and 98 wt % of water), using the same method as described above with respect to Working Example 1. Comparative Example B excludes a polyoxyethylene/polyoxypropylene polyol and is prepared with a 1:1 ratio of the MDI Prepolymer and a solution (which solution includes 2 wt % of Poloxamer 188 and 98 wt % of water), using the same method as described above with respect to Working Example 1.

The physical properties of Working Examples 1 and 2 and Comparative Examples A and B are evaluated according to Table 2, below.

TABLE 2

| | Working | Working | Comparative | Comparative |
|---|---|---|---|---|
| | Example 1 | Example 2 | Example A | Example B |
| Average NCO | 7.1-7.4 | 9.4 | 5.8-6.2 | 8.8-9.7 |
| content range | | | | |
| (wt %) | | | | |
| Cream Time | 15 | 10 | 20 | 15 |
| (seconds) | | | | |
| Tack Free Time | 4-5 | 1.5 | 3-3.5 | 13-14 |
| (minutes) | | | | |
| Wet Tear Strength | 578 | 1155 | 149 | 420 |
| (N/m) | | | | |

The average NCO content range is measured according to ASTM D-5155. Cream time is measured as a time difference between when reaction mixture is formed (with a prepolymer component and a water/surfactant component) until an increase in volume (i.e., a rise) of the reaction mixture is realized. Tack free time is measured as a time difference between when the reaction mixture is formed until a reaction product of the reaction mixture becomes tack free (i.e., a tongue depressor can be inserted into the reaction product without any stringing/sticking of the reaction product being realized). Wet tear strength is measured using a modified version of ASTM D-3574/F, in which the modification is that reaction product samples are immersed in deionized water for 60 seconds and pat dried for 30-40 second prior to the tear and tensile measurement.

As shown in Table 2, above, Working Examples 1 and 2 provide a good balance between performance (e.g., with respect to wet tear strength) and the reactivity profile (e.g., with respect to tack free time and cream time) in comparison to Comparative Examples A and B.

1. A reaction system for forming a hydrophilic polyurethane foam for liquid based cleaning applications, the reaction system comprising:
a composition that includes:
a prepolymer component that includes a reaction product of an isocyanate component that includes diphenylemethane diisocyanate (MDI) and a polyol component that includes a polyoxyethylene-polyoxypropylene polyol that has an polyoxyethylene content greater than 65 wt %, based on a total weight of the polyoxyethylene-polyoxypropylene polyol, and
an aqueous component that includes at least 60 wt % of water and at least 0.5 wt % of a surfactant, based on a total weight of the aqueous component,
wherein a weight ratio of the prepolymer component to the aqueous component in the composition is from 0.5:2 to 2:0.5, the composition has a cream time of less than 20 seconds and a tack free time of less than 7 minutes, and the hydrophilic polyurethane foam for liquid based cleaning applications has a wet tear strength of at least 500 N/m.

2. The reaction system as claimed in claim 1, wherein the polyoxyethylene-polyoxypropylene polyol has an average nominal hydroxyl functionality from 1.6 to 3.5 and a number average molecular weight from 1,500 to 8,000.

3. The reaction system as claimed in claim 2, wherein:
the polyol component includes a polyalkylene glycol based polyol that has a nominal hydroxyl functionality from 1.6 to 3.5 and a number average molecular weight from 1,500 to 8,000, and
a weight ratio of the polyoxyethylene-polyoxypropylene polyol to the polyalkylene glycol based polyol is from 1:5 to 1:15.

4. The reaction system as claimed in claim 3, wherein the polyalkylene glycol based polyol is a polyethylene glycol polyol or a polyalkylene glycol monobutyl ether.

5. The composition as claimed in claim 4, wherein the isocyanate component has a weight ratio from 0:100 to 50:50 of 2,4′ isomers of MDI to 4,4′ isomers of MDI.

6. A method of forming a sponge that is a hydrophilic polyurethane foam for liquid based cleaning applications, the method including curing the reaction system claimed in claim 5 to form the sponge that has the wet tear strength of at least 500 N/m.

7. The method as claimed in claim 6, wherein the sponge has a density from 8.5 lb/ft³ to 9.5 lb/ft³.

8. A method of forming a bath sponge that is a hydrophilic polyurethane foam for liquid based cleaning applications, the method including curing the composition claimed in claim 5 to form the bath sponge.

9. The method as claimed in claim 8, wherein the bath sponge has a density from 8.5 lb/ft³ to 9.5 lb/ft3.
